(19) United States
(12) Patent Application Publication
(10) Pub. No.: US 2010/0321884 A1
(43) Pub. Date: Dec. 23, 2010

(54) MOUNTING APPARATUS FOR PCI DEVICE

(75) Inventors: CHIN-WEN YEH, Tu-Cheng (TW); YANG XIAO, Shenzhen City (CN); CHANG-LIANG CHEN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/565,731

(22) Filed: Sep. 23, 2009

(30) Foreign Application Priority Data
Jun. 18, 2009 (CN) 200910303398.5

(51) Int. Cl. G06F 1/16

(52) U.S. Cl. 361/679.58

(57) ABSTRACT

A mounting apparatus is configured for a Peripheral Component Interconnect (PCI) device. The mounting apparatus includes a chassis and a latch plate. The chassis includes a plate. The chassis plate defines a slot therein. A blocking portion is located on an edge of the chassis slot. The latch plate is configured to be fixed on the PCI device, and includes a resiliently deformable locking portion. The locking portion is engageable with the chassis blocking portion.

### BACKGROUND

1. Technical Field

The present disclosure relates to mounting apparatuses, and particularly to a mounting apparatus for securing a Peripheral Component Interconnect (PCI) device.

2. Description of Related Art

A PCI device usually has a latch plate fixed thereon. The latch plate can be secured to a computer chassis. A mounting member is needed to secure the latch plate to the computer chassis. However, the mounting member increases cost in assembly of the PCI device.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, cutaway, isometric view of a mounting apparatus and a PCI device in accordance with an embodiment.

FIG. 2 is similar to FIG. 1, but shown from another aspect.

FIG. 3 is an assembled view of FIG. 1.

FIG. 4 is an assembled view of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

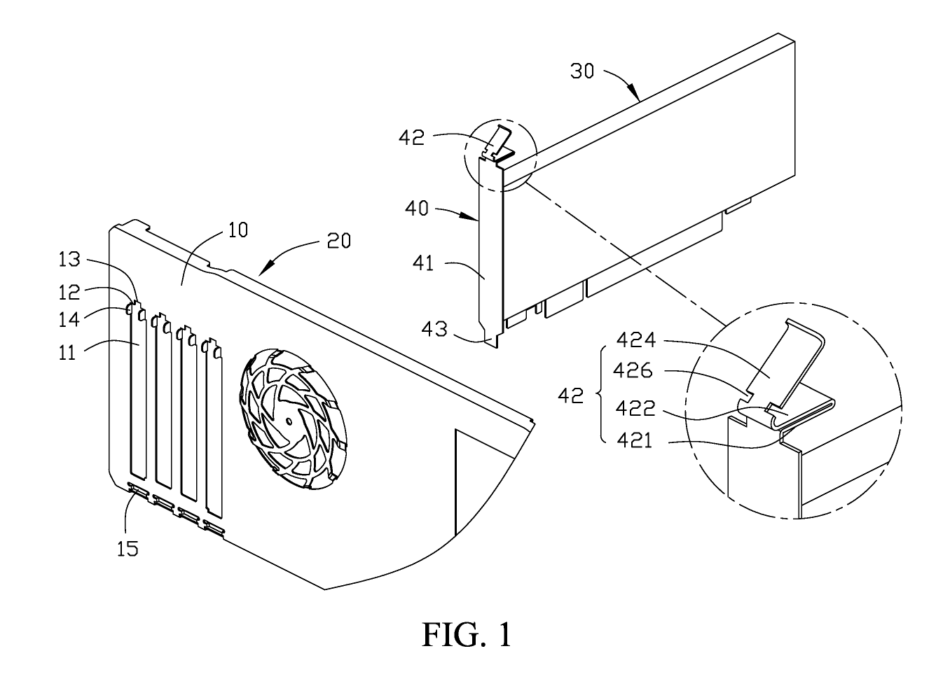

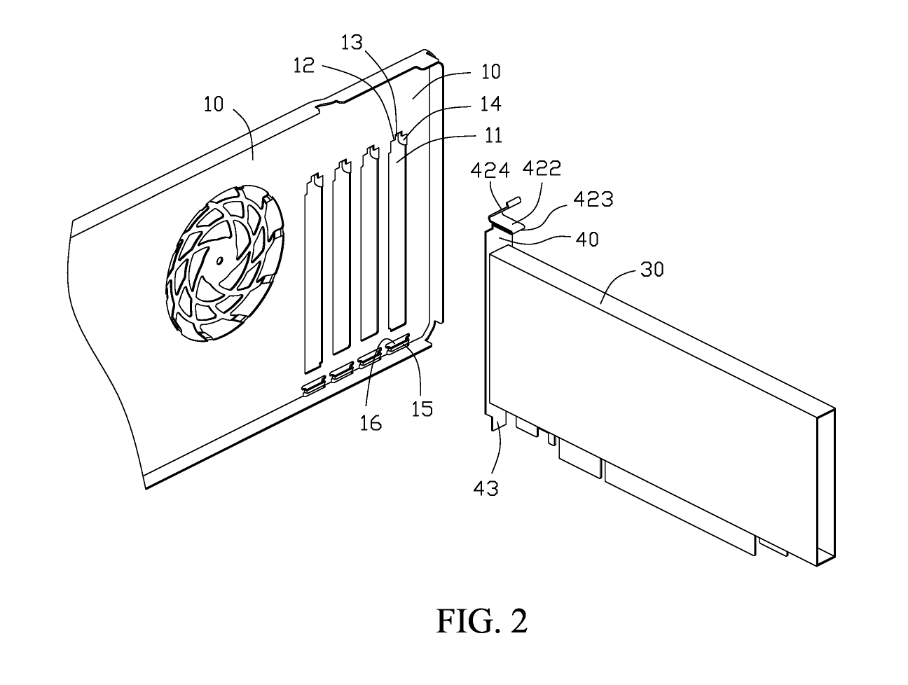

Referring to FIGS. 1-2, a mounting apparatus in accordance with an embodiment includes a chassis 20, and a latch plate 40 fixed on a Peripheral Component Interconnect (PCI) device.

The chassis 20 includes a plate 10. A plurality of slots 11 is defined in the chassis plate 10, and extends in a vertical direction. A cutout 13 is defined in a top edge of each chassis slot 11, so as to form blocking portions 12 at opposite parallel edges of the chassis cutouts 13. Two tabs 14 perpendicularly extend out from two parallel edges of each chassis slot 11 adjacent the chassis cutout 13. A bridge-shaped positioning clip 15 is located on the chassis plate 10 below each chassis slot 11, thus defining a slit 16 behind each positioning clip 15.

The latch plate 40 is configured to cover one of the chassis slots 11, and includes a base portion 41, a resiliently deformable locking portion 42 extending from the base portion 41, and an inserting portion 43 configured to engage in the chassis slit 16. The locking portion 42 is configured to engage in the chassis slot 11, and includes a first support piece 421 bent perpendicularly from a top edge of the latch plate 40, a second support piece 422 bent from a free edge of the first support piece 421 in a direction reverse to an extending direction of the first support piece 421, a resiliently deformable latch piece 424 bent slantedly from a free edge of the second support piece 422. Two cutouts 426 are defined in opposite edges of the latch piece 424, and are configured to receive the chassis blocking portions 12.

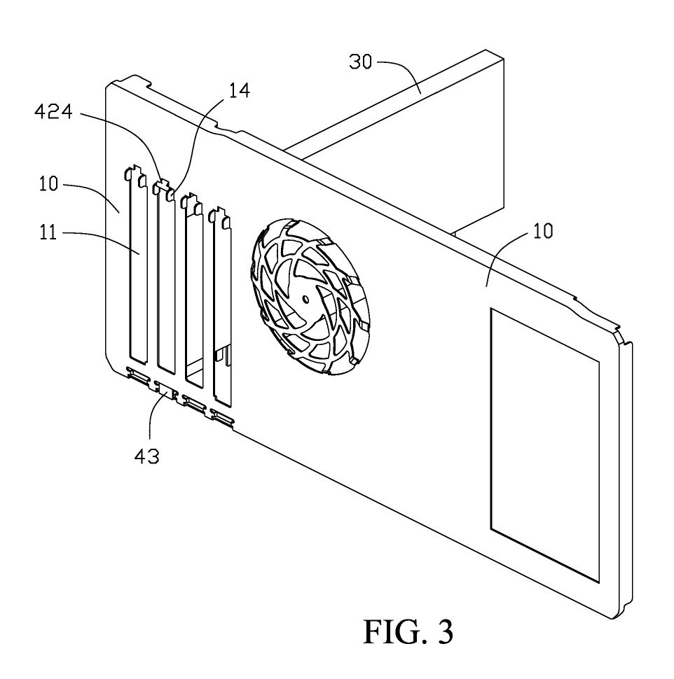

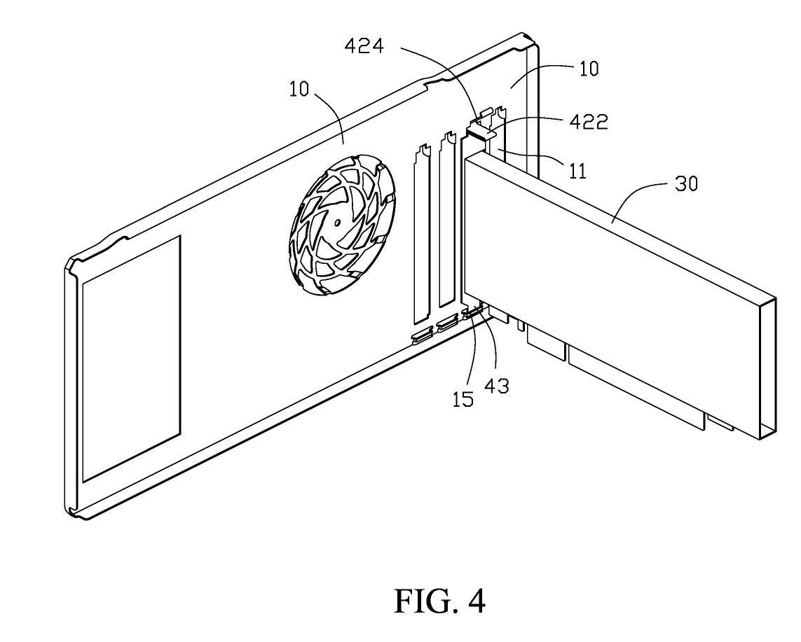

Referring also to FIGS. 3-4, in assembly of the PCI device 30, the PCI device 30 together with the latch plate 40 is placed in the chassis 20. The latch plate 40 abuts on the chassis plate 10. The PCI device 30 is pushed down to slide on the chassis plate 10. The latch plate inserting portion 43 is inserted in the chassis slit 16, and the latch plate locking portion 42 abuts the chassis blocking portions 12. The latch plate 40 is pushed to insert the latch plate locking portion 42 into the chassis slot 11. The chassis blocking portions 12 resiliently deform the latch piece 424, so that the latch plate locking portion 42 can be inserted into the chassis slot 11. The chassis blocking portions 12 is slid on the latch piece 424 to the latch piece cutouts 426. At this time, the latch piece 424 rebounds to engage the chassis blocking portion 12 in the latch piece cutouts 426, so that the latch plate locking portion 42 cannot be disengaged from the chassis slot 11. The PCI device 30 together with the latch plate 40 is thus secured on the chassis plate 20.

In addition, in the assembly of the PCI device 30, the latch piece 424 can be resiliently deformed toward the second support piece 422. The latch plate inserting portion 43 is inserted into the chassis slit 16, and the latch plate locking portion 42 is engaged in the chassis slot 11. The latch piece 424 is then released to thereby rebound, so that the chassis blocking portion 12 is engaged in the latch piece cutouts 426. The latch plate locking portion 42 cannot be disengaged from the chassis slot 11, and the PCI device 30 together with the latch plate 40 is thus secured on the chassis plate 20.

After the PCI device 30 together with the latch plate 40 is secured in the chassis 20, a part of the locking portion 42 inserted in the chassis slot 11 is positioned between the two chassis tabs 14, thereby preventing the locking portion 42 from swaying.

In disassembly of the PCI device 30, the latch piece 424 is resiliently deformed toward the second support piece 422, so as to disengage the chassis blocking portions 12 from the latch piece cutouts 426. The latch plate locking portion 42 is removed from the chassis slot 11, and the latch plate inserting portion 43 can be removed from the chassis slit 16. The PCI device 30 together with the latch plate 40 can be thus disassembled from the chassis 20.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus for a Peripheral Component Interconnect (PCI) device comprising:
a chassis comprising a plate, the chassis plate defining a slot therein, a blocking portion located on an edge of the chassis slot; and
a latch plate configured to be fixed on the PCI device, the latch plate comprising a resiliently deformable locking portion; wherein the locking portion is engageable with the chassis blocking portion.

2. The mounting apparatus of claim 1, wherein the chassis plate defines a cutout in an edge of the chassis slot, so as to form the blocking portion.

3. The mounting apparatus of claim 1, wherein the latch plate locking portion defines a cutout to receive the chassis blocking portion.

4. The mounting apparatus of claim 1, wherein the latch plate locking portion comprises a resiliently deformable latch piece for engaging in the chassis slot, and extends in slanted direction relative to the chassis plate.

5. The mounting apparatus of claim 4, wherein the latch plate locking portion further comprises a first support piece, and a second support piece bent from the first support piece and extending in a direction reverse to an extending direction of the first support piece.

6. The mounting apparatus of claim 6, wherein the latch piece extends slantedly from the second support piece.

7. A mounting apparatus for a Peripheral Component Interconnect (PCI) device comprising:
a chassis comprising a plate, the chassis plate defining a slot therein, a cutout being defined in an edge of the chassis slot; and
a latch plate configured to be fixed on the PCI device, the latch plate comprising a resiliently deformable locking portion, a cutout being defined in the latch plate locking portion; wherein an edge of the chassis cutout is engageable in the blocking portion cutout.

8. The mounting apparatus of claim 7, wherein the latch plate locking portion comprises a resiliently deformable latch piece for engaging in the chassis slot, and extends in slanted direction relative to the chassis plate.

9. The mounting apparatus of claim 8, wherein the locking portion cutout is defined in the locking portion latch piece.

10. The mounting apparatus of claim 8, wherein the latch plate locking portion further comprises a first support piece, and a second support piece bent from the first support piece; the second support piece extends in a direction reverse to an extending direction of the first support piece.

11. The mounting apparatus of claim 10, wherein the latch piece extends slantedly from the second support piece.

12. The mounting apparatus of claim 10, wherein the latch plate further comprises a base portion; the first support piece is bent perpendicularly from the base portion.

13. The mounting apparatus of claim 10, wherein a clip is located on the chassis plate;
the latch plate further comprises an inserting portion to engage between the chassis clip and the chassis plate.

14. A computer system comprising:
a chassis comprising a plate, the chassis plate defining a slot therein, a blocking portion located on an edge of the chassis slot; and
a latch plate fixed on a Peripheral Component Interconnect (PCI) device, the latch plate comprising a resiliently deformable latch piece extending slantedly relative to the chassis plate; wherein the latch piece is configured to insert in the chassis slot to engage with the chassis blocking portion.

15. The computer system of claim 14, wherein the chassis plate defines a cutout in an edge of the chassis slot, so as to form the blocking portion.

16. The computer system of claim 14, wherein the latch plate latch piece defines a cutout to receive the chassis blocking portion.

17. The computer system of claim 14, wherein the latch plate further comprises a base portion, a first support piece bent from the base portion, and a second support piece bent from the first support piece and extending in a direction reverse to an extending direction of the first support piece.

18. The computer system of claim 17, wherein the latch piece extends slantedly from the second support piece.
